(19) United States
(12) Patent Application Publication
(10) Pub. No.: US 2020/0274412 A1
(43) Pub. Date: Aug. 27, 2020

(54) VIBRATION OUTPUT DEVICE AND PORTABLE ELECTRONIC DEVICE FOR OUTPUTTING VIBRATION

(71) Applicant: YEIL ELECTRONICS CO., LTD., Incheon (KR)

(72) Inventors: Yoon Kyu KANG, Gyeonggi-do (KR); Jae Yong KIM, Busan (KR)

(21) Appl. No.: 16/066,213

(22) PCT Filed: Jan. 13, 2017
(86) PCT No.: PCT/KR2017/000500

§ 371 Date: Jun. 26, 2018

(30) Foreign Application Priority Data
Jan. 14, 2016 (KR) 1020160004622
Apr. 14, 2016 (KR) 1020160045384

(51) Int. Cl. H02K 1/34; H02K 33/16; H04R 9/06

(52) U.S. Cl. CPC H02K 1/34; H04R 2460/13; H04R 9/06; H02K 33/16

(57) ABSTRACT

According to an exemplary embodiment of the present invention, there are provided a vibration output device and a portable electronic device, which outputs vibration. An exemplary embodiment of the present invention provides a vibration output device, including: a magnetic circuit generating vibration; a yoke part contacting an upper surface of the magnetic circuit; an elastic member contacting with at least a part of an upper surface of the yoke part and performing vibratory motion; a housing having an opened upper surface, an opened lower surface and an internal space formed by closed lateral surfaces; a coil positioned inside the housing and receiving an alternating-current signal provided from an outside; and a vibration plate contacting at least a part of the upper surface of the yoke part and outputting vibration to the outside according to vibration of the yoke part.

### TECHNICAL FIELD

The present invention relates to a device for outputting vibration, and more particularly, to a device for outputting vibration and a portable electronic device including the device for outputting vibration.

### BACKGROUND ART

Products using a bone conduction technology, which has been widely known while being recently mounted to a portable phone, have appeared in succession. Various electronic devices, for example, application products including a speaker or a hearing aid, using the bone conduction technology, have been commercialized. Temuco Japan, which holds the patent related to bone conduction, has a plan to release a product, such as a speaker and a microphone, adopting a bone conduction technology, which is usable even in a vacuum state and is usable in any place, such as underwater.

In general, sound is recognized in a way that vibration of air stimulates an eardrum and vibration of the eardrum is transmitted to a cochlea. In contrast, in bone conduction, vibration is directly transmitted from a bone to a cochlea. With this principle, people hear sound even covering their ears. Accordingly, when a cochlea and auditory nerves are normal despite of a problem of an eardrum and the like, a person can hear sound through bone conduction.

The bone conduction technology itself has been already established, but there is difficulty in miniaturizing a product when the bone conduction technology is commercialized as a product. The reason is that an output by bone conduction is proportional to a size of a product. Accordingly, Temuco Japan invests greatly in development of a bone conduction speaker, which has a decreased number of components and has a changed internal structure. Further, Temuco Japan conducts research on a voice communication bone conduction speaker employing the bone conduction speaker.

In general, a sound or vibration output device is a sound or vibration-power output device, such as a speaker, a receiver, a buzzer, a vibration motor (vibrator), which converts an electric signal input from a signal source to a mechanical signal and outputs sound or generates vibration power, and a bone conduction output device also corresponds to the sound or vibration output device.

The sound or vibration output device is applied to many different fields according to a size and a usage thereof. Particularly, a small sound or vibration output device, particularly, a small vibration motor, which is widely used for vibratory calling of a communication terminal while meeting the growth of an information and communication industry, has rapidly and increasingly adopted a linear motion vibration motor, which has a function beyond a function of an existing rotary vibration motor, according to popularity of a touch screen terminal including a smart phone.

The linear motion vibration motor is widely applied to portable IT devices, such as a touch phone including a smart phone and a general portable phone, because of a higher response speed and less noise than those of a rotary vibration motor, and a considerably improved life. A response speed means time taken for reaching 50% of vibration power at a maximum displacement, which is the biggest reason for adopting the linear motion vibration motor.

Recently, a touch screen terminal is evolved to a smart phone and downloads various applications and is used, and the applications perform various functions and demand feedback vibration in accordance with the functions, and in order to meet the demand, there is a demand for a vibration motor having a higher response speed, that is, a higher reaction rate, than that of the linear motion vibration motor in the related art, in the art.

### DISCLOSURE

### Technical Problem

An object to be solved by an exemplary embodiment of the present invention is to provide a vibration output device, which is capable of directly transmitting vibration to a body and skin.

An object to be solved by another exemplary embodiment of the present invention is to provide a vibration output device, which has improved bone conductivity.

### Technical Solution

An exemplary embodiment of the present invention provides a vibration output device, including: a magnetic circuit generating vibration; a yoke part contacting an upper surface of the magnetic circuit; an elastic member contacting at least a part of an upper surface of the yoke part and performing vibratory motion; a housing having an opened upper surface, an opened lower surface and an internal space formed by closed lateral surfaces; a coil positioned inside the housing and receiving an alternating-current signal provided from an outside; and a vibration plate contacting the at least the part of the upper surface of the yoke part and outputting vibration to the outside according to vibration of the yoke part.

### Advantageous Effects

A vibration output device according to another exemplary embodiment of the present invention directly transmits vibration to a body and skin, thereby preventing degradation of bone conductivity and a distortion phenomenon due to a decrease in vibration.

The effect of the present invention is not limited to the foregoing, and those skilled in the art may clearly understand other non-mentioned effects from the description below.

### DESCRIPTION OF DRAWINGS

Various aspects are described with reference to the drawings, and herein, similar reference numerals are used for indicating generally similar constituent elements. In the exemplary embodiments below, for the purpose of explanation, a plurality of specific detailed matters is presented for general understanding of one or more aspects. However, it will be apparent that the aspect(s) may be carried out without the specific detailed matters. In other examples, publicly known structures and devices are illustrated in the form of a block diagram for easy description of one or more aspects.

FIGS. 1A, 1B, and 1C are diagrams illustrating a vibration output device according to an exemplary embodiment of the present invention.

FIG. 2 is a diagram illustrating a method of coupling an elastic member and a housing according to the exemplary embodiment of the present invention.

FIG. 3 is a diagram for describing the elastic member according to the exemplary embodiment of the present invention.

FIG. 4 is a diagram illustrating a yoke part according to the exemplary embodiment of the present invention.

FIG. 5 is a diagram illustrating a method, in which an elastic member 300 comes into contact with a yoke part 200, according to the exemplary embodiment of the present invention.

FIG. 6 is a diagram for describing a method of coupling constituent elements of the vibration output device 1000 without a rivet according to the exemplary embodiment of the present invention.

FIG. 7 is a diagram illustrating a structure of a vibration output device 1000 according to another exemplary embodiment of the present invention.

FIG. 8 is an exploded diagram illustrating a vibration output device according to the exemplary embodiment of the present invention.

FIGS. 9 and 10 are schematic diagrams illustrating a state where the vibration output device according to the exemplary embodiment of the present invention is mounted to a portable electronic device.

FIG. 11 is a schematic diagram illustrating a state where an elastic body according to the exemplary embodiment of the present invention vibrates in a predetermined space.

FIG. 12 is a diagram illustrating an elastic member that is in contact with an upper surface of a yoke part according to the exemplary embodiment of the present invention.

FIG. 13 is a diagram for describing a vibration output device including a housing 500 according to the exemplary embodiment of the present invention.

### BEST MODE

Objects, features, and advantages of the present invention will become more apparent through the following exemplary embodiment related to the accompanying drawings. Specific structures and functional descriptions below are simply illustrative for describing an exemplary embodiment according to a concept of the present invention, and exemplary embodiments according to the concept of the present invention may be carried out in various forms, and shall not be construed to be limited to the exemplary embodiments described in the present specification or the present application.

The exemplary embodiment according to the concept of the present invention may be variously changed, and may have various forms, so that the specific exemplary embodiments will be exemplified in the drawings and will be described in detail in the present specification or the present application. However, this does not intend to limit the exemplary embodiment according to the concept of the present invention to a specific disclosure form, and it will be appreciated that the present invention includes all modifications, equivalences, or substitutions included in the spirit and the technical scope of the present invention.

Terms, such as first and/or second, are used for describing various constituent elements, but the constituent elements are not limited by the terms. The terms are used only to discriminate one constituent element from another constituent element. For example, without departing from the scope of the invention, a first constituent element may be named as a second constituent element, and similarly a second constituent element may be named as a first constituent element.

It should be understood that when one constituent element is referred to as being “coupled to” or “connected to” another constituent element, one constituent element can be directly coupled to or connected to the other constituent element, but intervening elements may also be present. In contrast, when one constituent element is referred to as being “directly coupled to”, “directly connected to”, or “in contact with” another constituent element, it should be understood that there are no intervening elements. The same is applied to other expressions, that is “between” and “just between”, or “adjacent to” and “directly adjacent to”, for describing a relationship between constituent elements.

Terms used in the present specification are used only to describe specific exemplary embodiments, and are not intended to limit the present invention. Singular expressions used herein include plural expressions unless they have definitely opposite meanings in the context. In the present application, it will be appreciated that terms “including” and “having” are intended to designate the existence of characteristics, numbers, steps, operations, constituent elements, and components described in the specification or a combination thereof, and do not exclude a possibility of the existence or addition of one or more other characteristics, numbers, steps, operations, constituent elements, and components, or a combination thereof in advance.

All terms used herein including technical or scientific terms have the same meanings as meanings which are generally understood by those skilled in the art unless they are differently defined. Terms defined in generally used dictionary shall be construed that they have meanings matching those in the context of a related art, and shall not be construed in ideal or excessively formal meanings unless they are clearly defined in the present application.

Hereinafter, exemplary embodiments of the present invention will be described in more detail with reference to the accompanying drawings.

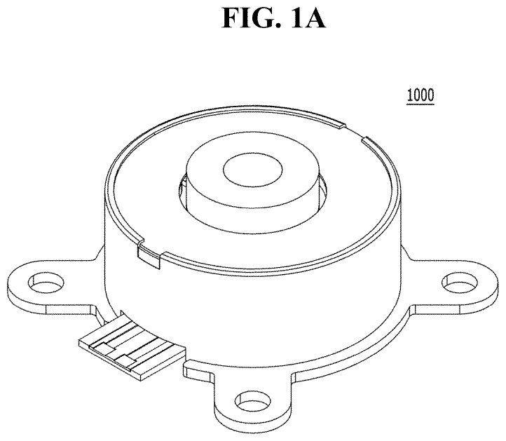

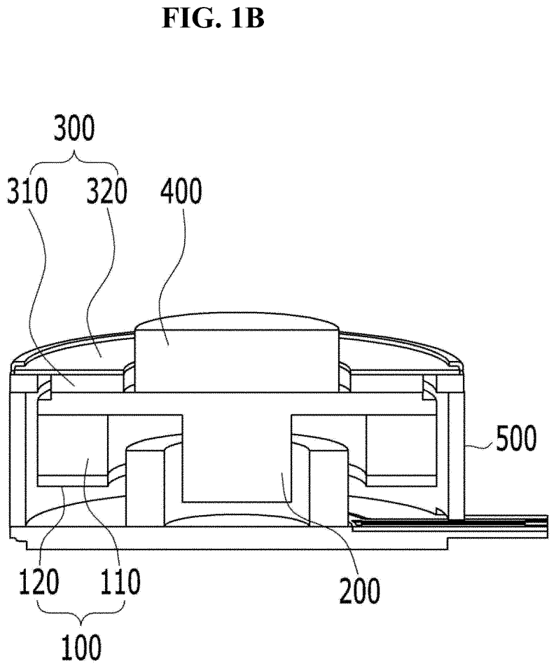

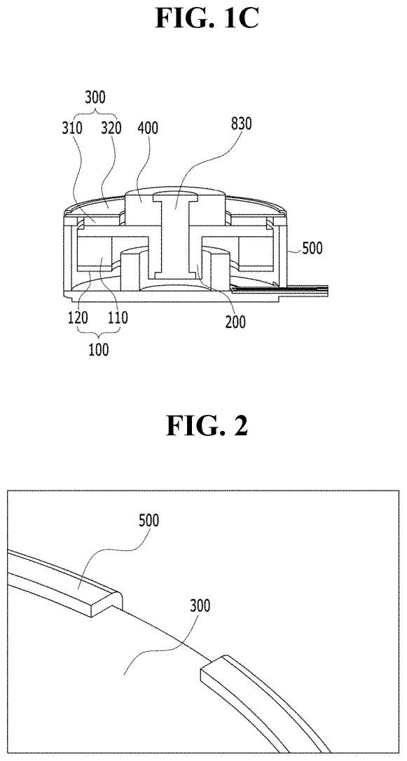

FIGS. 1A, 1B, and 1C are diagrams illustrating a vibration output device according to an exemplary embodiment of the present invention.

FIG. 1A is a diagram illustrating an external appearance of a vibration output device according to an exemplary embodiment of the present invention. FIG. 1B is a diagram illustrating a structure of the vibration output device according to the exemplary embodiment of the present invention. Referring to FIG. 1B, the vibration output device 1000 according to the exemplary embodiment of the present invention may include a magnetic circuit 100, a yoke part 200, an elastic member 300, and a housing 500.

The magnetic circuit 100 may generate vibration. The magnetic circuit 100 may include a magnet 110 and a top plate 120. Herein, the magnet 110 may be formed of a material having magnetic force, and may vibrate according to a change in a peripheral magnetic field. Further, the top plate 120 may concentrate magnetic force of the magnet 110.

The magnetic circuit 100 may be provided with a coil 130 with a predetermined interval. When an alternating-current signal is applied to the coil 130, the magnet 110 may vibrate according to a direction and an intensity of the alternating-current signal applied to the coil 130 and a size of frequency. That is, the magnet 110 may serve as a vibrator that vibrates according to the alternating-current signal applied to the coil 130.

This is caused by Fleming's left-hand law that a conductor laid within a magnetic field receives force in a predetermined direction, and a theory related to the principle thereof is a publicly known technology, so that a detailed description thereof will be omitted.

In the related art, a vibration motor using a brush and a commutator is frequently used, but has a problem in excessive noise and miniaturization. The vibration output device 1000 of the present invention may include the coil 130 and the magnetic circuit 100 for generating vibration, and vibration generated by the magnetic circuit 100 may be transmitted to the yoke part 200 that is in contact with an upper surface of the magnetic circuit 100.

The yoke part 200 may be provided to be in contact with the upper surface of the magnetic circuit 100. Herein, the state where the yoke part 200 is in contact with the magnetic circuit 100 means that a separate vibration transmission substance is not provided between the yoke part 200 and the magnetic circuit 100, and vibration generated by the magnetic circuit 100 is directly transmitted to the yoke part 200. That is, vibration generated by the magnetic field 100 may be directly transmitted to the yoke part 200 by sequentially stacking the yoke part 200 on the upper surface of the magnetic circuit 100, or integrally manufacturing the yoke part 200 and the magnetic circuit 100 at the timing of the manufacturing.

The elastic member 300 may include a plurality of constituent elements. For example, the elastic member 300 may include an elastic body 310 and an elastic body suspension 320.

The elastic member 300 may be formed by various methods. For example, the elastic member 300 may be formed by coupling the elastic body 310 and the elastic body suspension 320 which are separately formed. Further, the elastic body 310 and the elastic body suspension 320 may be integrally molded by a cast scheme using a metal member, but the present invention is not limited thereto.

The housing 500 has an opened upper surface, an opened lower surface and an internal space formed by closed lateral surfaces. For example, the housing 500 may have the form of a cylinder of which an upper surface and a lower surface are opened. Further, the housing 500 may have the form of a quadrangle of which an upper surface and a lower surface are opened, but is not limited thereto.

The housing 500 may include at least one constituent element of the vibration output device in the internal space. For example, the coil 130, the magnetic circuit 100, the yoke part 200, and the elastic 300, or a combination thereof may be included in the internal space of the housing 500, but the present invention is not limited thereto.

The housing 500 may be molded with various members. The housing 500 may be molded with a metal member (for example, iron, nickel, and copper), and may be molded with reinforced plastic, but is not limited thereto.

Referring to FIG. 1B, the vibration plate 400 and the yoke part 200 may be coupled by directly attaching the vibration plate 400 and the yoke part 200 without a rivet 830. Further, referring to FIG. 1C, according to another exemplary embodiment of the present invention, the vibration plate 400 and the yoke part 200 may be coupled by the rivet 830.

FIG. 2 is a diagram illustrating a method of coupling the elastic member and the housing according to the exemplary embodiment of the present invention.

According to the exemplary embodiment of the present invention, the vibration output device 1000 may include the housing 500 and the elastic member 300.

The housing 500 and the elastic member 300 may be coupled by various methods. For example, the elastic member 300 is attached to an internal surface of the housing 500, thereby being coupled with the housing 500. Further, the elastic member 300 may be coupled with the housing 500 by curling of the housing 500.

Referring to FIG. 2, at least a part of an upper portion of the housing 500 is curled in a direction of the elastic member 300, so that the elastic member 300 may be seated on an upper surface of the housing 500.

The curling means bending at a predetermined angle, and the predetermined angle may be determined by various methods.

For example, the predetermined angle may be determined to 90°, and may be determined to an optimum angle for fixing the elastic member 300, but is not limited thereto.

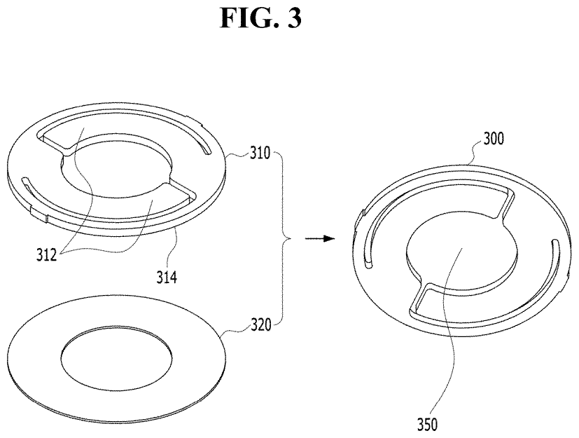

FIG. 3 is a diagram for describing the elastic member according to the exemplary embodiment of the present invention.

The elastic member 300 according to the exemplary embodiment of the present invention may include the elastic body 310. The elastic body 310 may include a vibration part 312 and a fixed part 314. The vibration part 312 of the elastic body 310 may be in contact with at least a part of an upper surface of the yoke part 200 and vibrate according to vibration of the magnetic circuit 100. A lower surface of the vibration part 312 of the elastic body 310 is in contact with the upper surface of the yoke part 200 and a lower surface of the yoke part 200 is in contact with the upper surface of the magnetic circuit 100, so that the vibration generated by the magnetic circuit 100 may be directly transmitted to the elastic member 300 through the yoke part 200.

For example, when the magnetic circuit 100 moves in an upper direction, the yoke part 200 that is in contact with the upper surface of the magnetic circuit 100 and the vibration part 312 of the elastic body 310 that is in contact with the upper surface of the yoke part 200 also move in the upper direction. In this case, the fixed part 314 of the elastic body 310 may be fixed to the housing 500 and may not move.

The vibration part 312 of the elastic body 310, which has moved in the upper direction, may receive power in a lower direction by elasticity of the elastic body 310, and the vibration part 312 of the elastic body 310 may move in the lower direction. The magnetic circuit 100 and the yoke part 200 may perform vibratory motion, in which the magnetic circuit 100 and the yoke part 200 vertically move, while repeating the foregoing process.

For another example, when the magnetic circuit 100 moves in the lower direction, the yoke part 200 that is coupled to the upper surface of the magnetic circuit 100 and the vibration part 312 of the elastic body 310 that is coupled to the upper surface of the yoke part 200 also move in the lower direction. In this case, the fixed part 314 of the elastic body 310 may be fixed to the housing 500 and may not move.

The vibration part 312 of the elastic body 310, which has moved in the lower direction, may receive power in the upper direction by elasticity of the elastic body 310, and the vibration part 312 of the elastic body 310 may move in the upper direction. The magnetic circuit 100 and the yoke part 200 may perform vibratory motion, in which the magnetic circuit 100 and the yoke part 200 vertically move, while repeating the foregoing process.

An opening portion 350 may be positioned at a center portion of the elastic body 310. Further, the vibration part 312 may be positioned in an external direction of the opening portion 350 of the elastic body 310, and the fixed part 314 may be positioned in an external direction of the vibration part 312. The vibration part 312 and the fixed part 314 may be connected through a connection portion.

Further, a space is formed between the vibration part 312 and the fixed part 314, so that when the vibration part 312 vibrates, the vibration part 312 may not be bumped into the fixed part 314.

The elastic body 310 may include a plurality of vibration parts 312, and each vibration part 312 may be connected to the fixed part 314 by the connection portion.

According to another exemplary embodiment of the present invention, the elastic member 300 of the present invention may further include an elastic body suspension 320.

The elastic body suspension 320 may be in contact with at least a part of the upper surface of the elastic body 310. Further, the elastic body suspension 320 may be attached to at least a part of the upper surface of the elastic body 310, thereby being coupled with the elastic body 310. For example, at least a part of the lower surface of the elastic body suspension 320 may be attached to at least a part of the upper surface of the fixed part 314 in the upper surface of the elastic body 310, thereby being coupled with the elastic body 310.

The elastic body suspension 320 may have the form of a circular plate, which has the opening portion 350 at a center portion thereof. Further, the elastic body suspension 320 may have the form that is capable of covering the upper surface of the elastic body 310, but is not limited thereto.

The elastic body suspension 320 is seated on the upper surface of the elastic body 310, thereby protecting the elastic body 310 and increasing exciting force of the elastic member 300, but the elastic body suspension 320 is not limited thereto and may exert various effects.

The elastic member 300 may have the opening portion at the center portion thereof. For example, the elastic member 300 may include the opening portion 350, and may be integrally formed with the opening portion 350 so that the vibration plate 400 is exposed to the outside through the opening portion 350. The vibration plate 400 is exposed to the outside, thereby being in direct contact with a body and the like.

The elastic member 300 may be seated on the upper surface of the housing 500 by various schemes. For example, the elastic member 300 may be attached to the internal surface of the housing 500, thereby being seated on the upper surface of the housing 500.

Further, for another example, at least a part of the upper portion of the housing 500 is curled in the direction of the elastic member 300, so that the elastic member 300 may be seated on the upper surface of the housing 500. Further, at least a part of an internal surface of the upper portion of the housing 500 is curled in the direction of the elastic member 300, so that the elastic member 300 may be seated on the upper surface of the housing 500.

The elastic member 300 is coupled with the housing 500, thereby being fixed. For example, the fixed part 314 of the elastic body 310 of the elastic member 300 is coupled with the housing 500, thereby being fixed.

According to another exemplary embodiment, the elastic member 300 may be integrally formed with the housing 500. For example, the elastic member 300 and the housing 500 may be integrally molded by a casting scheme using a metal member, but the present invention is not limited thereto.

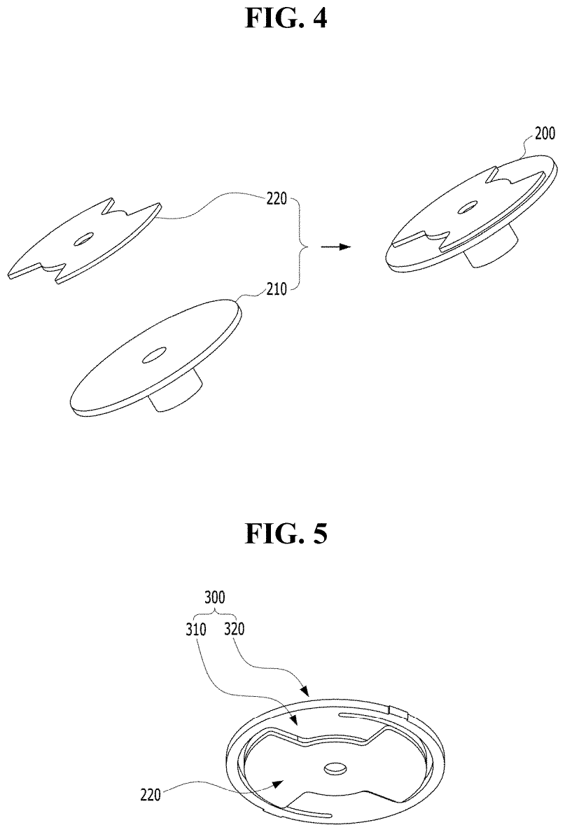

FIG. 4 is a diagram illustrating the yoke part according to the exemplary embodiment of the present invention.

According to the exemplary embodiment of the present invention, the yoke part 200 may transmit the vibration generated by the magnetic circuit 100 to the elastic member 300. For example, when the magnetic circuit 100 vibrates according to the alternating-current signal applied to the coil 130, the vibration may be directly transmitted to the yoke part 200 that is in contact with the magnetic circuit 100, and the vibration transmitted to the yoke part 200 may be transmitted up to the elastic member 300 that is in contact with the upper surface of the yoke part 200.

According to the exemplary embodiment of the present invention, the yoke part 200 may include a yoke 210.

The yoke 210 may include an upper surface in the form of a circular plate. At least a part of the upper surface of the yoke 210 is in contact with at least a part of the lower surface of the elastic member 300, so that the yoke 210 may transmit the vibration transmitted from the magnetic circuit 100 to the elastic member 300.

The yoke 210 may include a lower surface in the form of a circular plate. Further, the yoke 210 may include a lower surface in the form, in which a cylinder is attached to a center portion of a circular plate.

The foregoing form of the yoke 210 is simply the exemplary embodiment, and the form of the yoke 210 may be various.

According to another exemplary embodiment, the yoke part 200 may further include a yoke plate 220.

The yoke plate 220 may be seated on the upper surface of the yoke 210. For example, the yoke plate 220 may be in contact with at least a part of the upper surface of the yoke 210, may be attached to at least a part of the upper surface of the yoke 210, and may be integrally molded with the yoke 210, but is not limited thereto.

The yoke plate 220 is seated on the upper surface of the yoke 210, so that the yoke part 200 may have the upper surface including at least one step.

The yoke part 200 may include at least one step on the upper surface thereof. A space, in which the elastic member 300 is capable of vibrating, may be formed in the upper surface of the yoke part 200 by at least one step formed on the upper surface of the yoke part 200.

In this case, a part of the elastic member 300 may be in contact with at least a part of the upper surface of the yoke plate 220 of the yoke part 200. When the magnetic circuit 100 vibrates according to the alternating-current signal applied to the coil 130, the vibration generated by the magnetic circuit 100 may be transmitted to the yoke part 200, and the vibration transmitted to the yoke part 200 may be transmitted to the elastic body 310 that is in contact with the upper surface of the yoke part 200.

FIG. 5 is a diagram illustrating a method, in which the elastic member 300 comes into contact with the yoke part 200, according to the exemplary embodiment of the present invention.

The yoke part 200 may include the yoke plate 220. Further, at least a part of the upper surface of the yoke plate 220 may be in contact with at least a part of the lower surface of the elastic member 300. In this case, a space, in which the elastic member 300 is capable of vibrating, may be formed in the upper surface of the yoke part 200 by the yoke plate 220.

A part of the elastic member 300 may be in contact with at least a part of the upper surface of the yoke plate 220 of the yoke part 200. For example, at least a part of the vibration part 312 of the elastic member 300 may be in contact with at least a part of the upper surface of the yoke plate 220 of the yoke part 200.

The elastic member 300 and the yoke part 200 may be coupled by various schemes. For example, at least a part of the lower surface of the elastic member 300 is attached to at least a part of the upper surface of the yoke part 200, so that the elastic member 300 and the yoke part 200 may be coupled. Further, the elastic member 300 and the yoke part 200 may be coupled by the rivet 830. Further, the elastic member 300 and the yoke part 200 may be integrally molded to be coupled, but are not limited thereto.

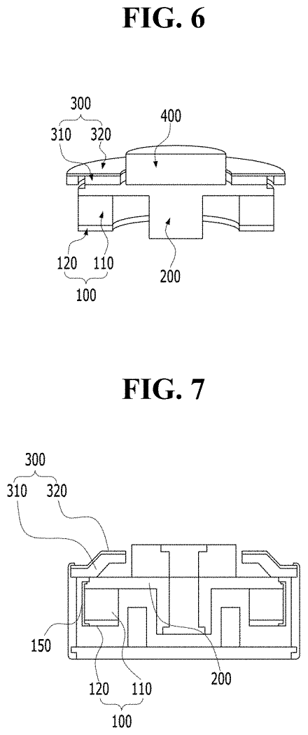

FIG. 6 is a diagram for describing a method of coupling constituent elements of the vibration output device 1000 without a rivet according to the exemplary embodiment of the present invention.

According to the exemplary embodiment of the present invention, the magnetic circuit 100 may include the top plate 120 and the magnet 110. The magnet 110 may be formed of a material having magnetic force, and may vibrate according to a change in a peripheral magnetic field. Further, the top plate 120 may concentrate magnetic force of the magnet 110.

The upper surface of the magnetic circuit 100 may be coupled with at least a part of the lower surface of the yoke part 200. In this case, the magnetic circuit 100 is directly attached to the yoke part 200, thereby being coupled with the yoke part 200.

The magnetic circuit 100 may be coupled to at least a part of the lower surface of the yoke part 200, and at least a part of the elastic member 300 may be coupled to at least a part of the upper surface of the yoke part 200. For example, the vibration part 312 of the elastic member 300 may be attached to at least a part of the upper surface of the yoke part 200.

In this case, the upper surface of the yoke part 200 may have the form of a circular plate having no step. Further, at least one step is formed on the upper surface of the yoke part 200 to form a space, in which the elastic member 300 is capable of vibrating, but the present invention is not limited thereto.

The vibration plate 400 may be additionally in contact with at least a part of the upper surface of the yoke part 200. In this case, the vibration plate 400 may be attached to the upper surface of the yoke part 200.

According to the exemplary embodiment of the present invention, the magnetic circuit 100 is attached to at least a part of the lower surface of the yoke part 200, the elastic member 300 is attached to at least a part of the upper surface of the yoke part 200, and the vibration plate 400 is attached to at least a part of the upper surface of the yoke part 200, thereby providing the vibration output device 1000 having no rivet 830.

FIG. 7 is a diagram illustrating a structure of a vibration output device 1000 according to another exemplary embodiment of the present invention.

According to the exemplary embodiment of the present invention, a magnetic circuit 100 and a yoke part 200 may be fixed by a magnetic circuit guide 150. In this case, the magnetic circuit 100 and the yoke part 200 are not directly attached, and may be coupled by the magnetic circuit guide 150.

The magnetic circuit guide 150 may be in contact with one lateral surface of each of the magnetic circuit 100 and the yoke part 200, thereby coupling the magnetic circuit 100 and the yoke part 200. For example, the magnetic circuit guide 150 is curled, so that the magnetic circuit 100 and the yoke part 200 may be coupled with each other.

For example, the magnetic circuit guide 150 may be positioned while being in contact with an external surface of the magnetic circuit 100, and at least a part of a lower end of the magnetic circuit guide 150 may be curled in a direction of the magnetic circuit 100. Further, the magnetic circuit guide 150 may be positioned while being in contact with an external surface of the yoke part 200, and at least a part of an upper end of the magnetic circuit guide 150 may be curled in a direction of the yoke part 200. In this case, the magnetic circuit guide 150 is curled, so that the magnetic circuit 100 and the yoke part 200 may be coupled with each other.

According to the exemplary embodiment of the present invention, an elastic member 300 may have structures in various forms.

For example, an elastic body 310 of the elastic member 300 is formed with two bent portions, which are bent at a predetermined angle, to form a step. In this case, an elastic body suspension 320 may be formed with two bent portions, which are bent at a predetermined angle, like the elastic body 310, in order to cover an upper surface of the elastic body 310.

The foregoing number of bent portions is simply an example, and the number of bent portions is not limited thereto.

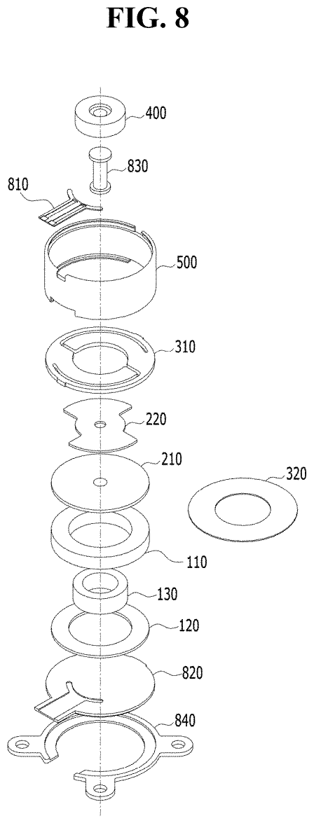

FIG. 8 is an exploded diagram illustrating a vibration output device according to the exemplary embodiment of the present invention.

Referring to FIG. 8, the vibration output device 1000 according to the exemplary embodiment of the present invention may include a printed circuit board (PCB) substrate 810. The PCB substrate 810 may be provided on at least a part of an upper surface of a cap 820. The cap 820 may connect a housing 500 and the PCB substrate 810 to fix the housing 500 and the PCB substrate 810. As described above, the housing 500 has the opened upper surface and lower surface, and has the form of the cylinder, thereby having the space therein. A coil 130 may be provided in the internal space of the housing 500. The coil 130 may provide a change in a magnetic field according to the alternating-current signal applied from the outside. The magnetic circuit 100 may be provided while not being in contact with the coil 130 at a predetermined interval. The magnetic circuit 100 may be provided with the top plate 120, which is capable of concentrating magnetic force of the magnet 110.

The yoke part 200 may be provided on the upper surface of the magnetic circuit 100, and vibration of the magnetic circuit 100 may be transmitted to the yoke part 200. In this case, the magnetic circuit 100 may be directly attached to the yoke part 200 to be coupled with the yoke part 200, and may be coupled with the yoke part 200 by the magnetic circuit guide 150.

The upper surface of the yoke part 200 may have various forms. For example, the upper surface of the yoke part 200 may have the form of a flat circular plate having no step. Further, the upper surface of the yoke part 200 includes at least one step, thereby forming a space, in which the elastic member 300 is capable of vibrating.

The vibration part of the elastic member 300 may be in contact with a part of the upper surface of the yoke part 200, and the fixed part 314 of the elastic member 300 may be in contact with at least a part of the internal surface of the housing 500. In this case, the elastic member 300 may be coupled with the housing 500 by curling of the housing 500, and may be directly attached to the internal surface of the housing 500 to be coupled with the housing 500, but the present invention is not limited thereto.

The vibration plate 400 is provided on the upper surface of the yoke part 200, thereby transmitting vibration of the magnetic circuit 100 to a user and the like. Further, a through-hole, through which the rivet 830 may be connected, may be formed at centers of the yoke part 200 and the vibration plate 400.

At least a part of the foregoing constituent elements may be coupled by the rivet 830. For example, the elastic member 300, the yoke part 200, and the vibration plate 400 may be coupled by the rivet 830.

Further, each of the constituent elements may be coupled by other schemes, without using the rivet 830. For example, the elastic member 300 is directly attached to the yoke part 200 and the vibration plate 400 is also directly attached to the yoke part 200, so that the vibration output device 1000 may have a structure having no rivet 830.

An exemplary embodiment of the present invention may provide a portable electronic device including the foregoing vibration output device. The portable electronic device may include an electronic device requiring transmission of a voice signal or a vibration signal. For example, the portable electronic device may be any one of the various electronic devices, such as a portable terminal, a mobile terminal, a telematics terminal, a notebook computer, a digital broadcasting terminal, a personal digital assistant (PDA), a Wibro terminal, an Internet protocol television (IPTV) terminal, an audio video navigation (AVN) terminal, a portable multimedia player (PMP), a navigation terminal (vehicle navigation device), and a speaker. Further, the portable electronic device may include Google glasses of Google.

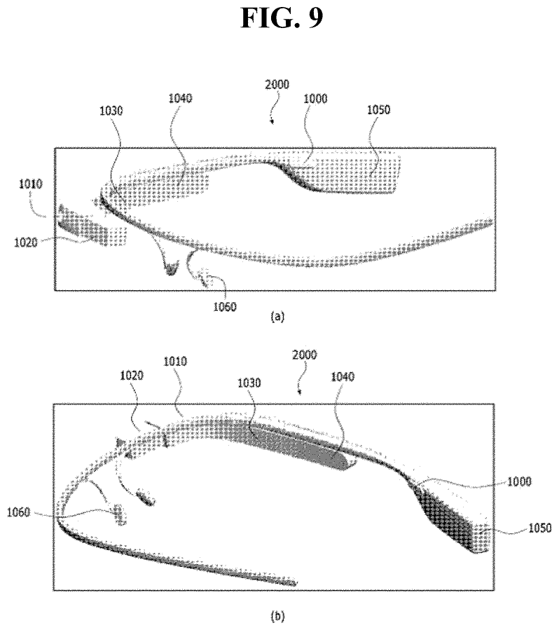

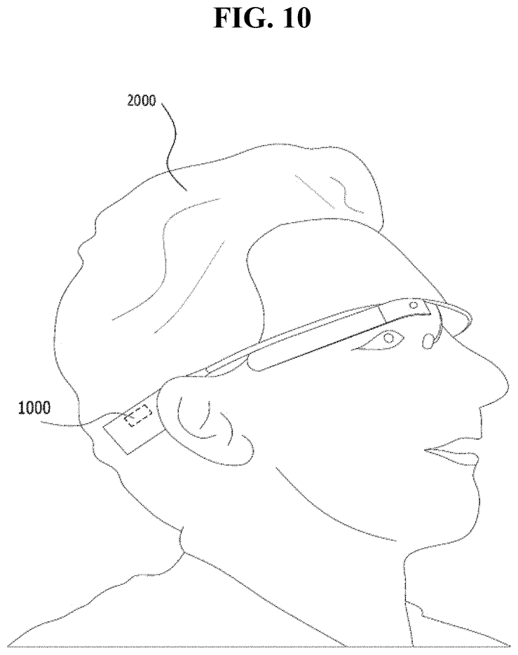

FIGS. 9 and 10 are schematic diagrams illustrating a state where the vibration output device according to the exemplary embodiment of the present invention is mounted to a portable electronic device.

Referring to FIGS. 9A and 9B, the vibration output device 1000 according to the exemplary embodiment of the present invention may be mounted to an internal side of a portable electronic device 2000. Herein, the portable electronic device 2000 may include Google glasses 2000 of Google. The Google glasses 2000 may include a camera 1010, which is capable of photographing an outside image, and a visual overlay 1020, which is capable of providing a user and the like with an image. Further, the Google glasses 2000 may include a communication module 1030, which is capable of exchanging data with an outside communication network, and a calculation processing device 1040, such as a central processing unit (CPU), which is capable of calculating received data. Further, the Google glasses 2000 may include a chargeable battery part 1050, which is capable of supplying energy, and a support means 1060, which assists a user and the like in wearing the Google glasses like glasses. Further, the Google glasses 2000 according to the exemplary embodiment of the present invention may include the vibration output device 1000 including the magnetic circuit 100, the yoke part 200, and the elastic member 300. For example, the vibration output device 1000 may be installed in a portion, in which the Google glasses 2000 are in contact with a bone conductive region of a user and the like.

As illustrated in FIG. 10, the user and the like may wear the Google glasses 2000, and may receive a voice signal and a sound signal, such as music, as a vibration signal, through the vibration output device 1000 provided in the Google glasses 2000.

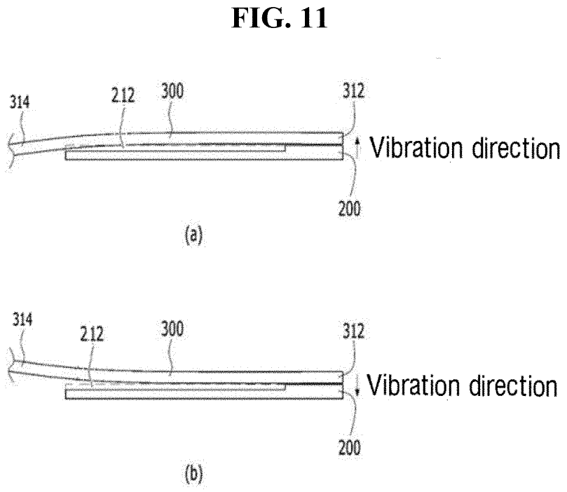

FIG. 11 is a schematic diagram illustrating a state where the elastic body according to the exemplary embodiment of the present invention vibrates in a predetermined space.

Referring to FIG. 11A, when the magnetic circuit 100 moves in the upper direction, the yoke part 200 that is in contact with the upper surface of the magnetic circuit 100 also moves in the upper direction, and the vibration part 312 of the elastic body 310 also moves in the same direction. In this case, the fixed part 314 of the elastic body 310 does not move, so that the elastic body 310 may be bent by elasticity. A bendable space 212 needs to be provided in order to enable the elastic body 310 to be bent, so that the space 212, in which the elastic body 310 is capable of performing vibratory motion, may be provided on the upper surface of the yoke part 200 according to the exemplary embodiment of the present invention.

Referring to FIG. 11B, when the magnetic circuit 100 moves in the lower direction, the yoke part 200 that is in contact with the upper surface of the magnetic circuit 100 also moves in the lower direction, and the vibration part 312 of the elastic body 310 also moves in the same direction. In this case, the fixed part 314 of the elastic body 310 does not move, so that the elastic body 310 may be bent by elasticity.

FIG. 11 schematically represents the degree of bending of the elastic body 310, but the scope of the present invention is not limited to a specific modulus of elasticity of the elastic body 310 or a specific bending angle of the elastic body 310. However, in order to increase an intensity of vibration, it is necessary to increase an amplitude of vibration of the yoke part 200 and the elastic body 310 and secure the large space 212, in which the elastic body 310 vibrates, so that the yoke plate 220 having various forms is provided on the upper surface of the yoke part 200 according to performance of the vibration output device 1000, thereby providing the space 212 having various volumes in the upper surface of the yoke part 200.

In order to enable the elastic body 310 according to the exemplary embodiment of the present invention to perform vibratory motion, in which the elastic body 310 vertically moves, it is necessary to provide a fixed reference point so as for the vibration part 312 of the elastic body 310 to vibrate. Accordingly, the elastic body 310 according to the exemplary embodiment of the present invention may include the fixed part 314. The fixed part 314 of the elastic body 310 may be coupled to a non-vibrating part, such as the housing 500.

FIG. 12 is a diagram illustrating the elastic member that is in contact with the upper surface of the yoke part according to the exemplary embodiment of the present invention.

Referring to FIG. 12, the elastic body 310 included in the vibration output device 1000 according to the exemplary embodiment of the present invention may be in contact with a part of the upper surface of the yoke part 200. For example, the elastic body 310 included in the vibration output device 1000 may include the vibration part 312 and the fixed part 314, and the vibration part 312 of the elastic body 310 may be in contact with at least a part of the upper surface of the yoke part 200.

For example, when the yoke part 200 includes the yoke plate 220, the vibration part 312 of the elastic body 310 may be in contact with at least a part of the upper surface of the yoke plate 220.

For another example, when the yoke part 200 does not include the yoke plate 220, the vibration part 312 of the elastic body 310 may be in contact with at least a part of the upper surface of the yoke 210. The yoke part 200, the yoke 210, and the yoke plate 220 have been described in detail with reference to FIG. 4.

The space 212, in which the elastic body 310 is capable of vibrating, may be formed in the upper surface of the yoke part 200, so that a part of the elastic body 310 may be in contact with a part of the upper surface of the yoke part 200, excluding a portion, in which the space 212 is formed.

According to the exemplary embodiment of the present invention, the vibration plate 400 may be in contact with the upper surface of the yoke part. The vibration plate 400 is in contact with the upper surface of the yoke part 200 and passes through the opening portion 350 of the elastic member 300 that is in contact with the upper surface of the yoke part 200, thereby being exposed to the outside.

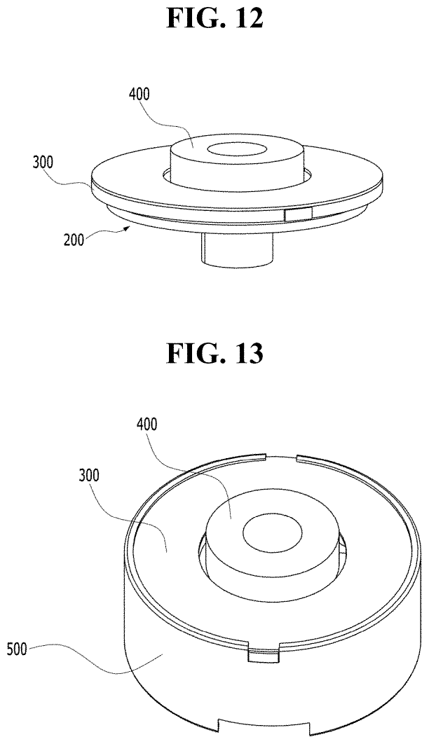

FIG. 13 is a diagram for describing a vibration output device including the housing 500 according to the exemplary embodiment of the present invention.

According to the exemplary embodiment of the present invention, the vibration output device 1000 may include the housing 500.

The housing 500 has opened upper surface and lower surface and close lateral surfaces to have a space therein. For example, the housing 500 may have the form of a cylinder of which an upper surface and a lower surface are opened. Further, the housing 500 may have the form of a quadrangle of which an upper surface and a lower surface are opened, but is not limited thereto.

The housing 500 may include at least one constituent element of the vibration output device in the internal space. For example, the coil 130, the magnetic circuit 100, the yoke part 200, and the elastic 300, or a combination thereof may be included in the internal space of the housing 500, but the present invention is not limited thereto.

The housing 500 may be molded with various members. The housing 500 may be molded with a metal member (for example, iron, tickle, and copper), and may be molded with reinforced plastic, but is not limited thereto.

According to the exemplary embodiment of the present invention, the housing 500 and the elastic member 300 may be coupled by various methods. For example, the elastic member 300 is attached to an internal surface of the housing 500, thereby being coupled with the housing 500. Further, the elastic member 300 may be coupled with the housing 500 by curling of the housing 500. For example, at least a part of the upper portion of the housing 500 is curled in the direction of the elastic member 300, so that the elastic member 300 may be seated on the upper surface of the housing 500.

The elastic member 300 is coupled with the housing 500, thereby being fixed. For example, the fixed part 314 of the elastic body 310 of the elastic member 300 is coupled with the housing 500, thereby being fixed.

According to another exemplary embodiment, the elastic member 300 may be integrally formed with the housing 500. For example, the elastic member 300 and the housing 500 may be integrally molded by a casting scheme using a metal member, but the present invention is not limited thereto.

In the forgoing, the present invention has been described with reference to the exemplary embodiment of the present invention, but those skilled in the art may appreciate that the present invention may be variously corrected and changed within the range without departing from the spirit and the area of the present invention described in the appending claims.

### MODE FOR CARRYING OUT THE INVENTION

Related contents have been described in the best mode for carrying out the invention.

### INDUSTRIAL AVAILABILITY

The present invention is usable in various electronic devices using a bone conduction technology.

1. A vibration output device comprising:
a magnetic circuit generating vibration;
a yoke part contacting an upper surface of the magnetic circuit;
an elastic member contacting at least a part of an upper surface of the yoke part and performing vibratory motion;
a housing having an opened upper surface, an opened lower surface, and an internal space formed by closed lateral surfaces;
a coil positioned inside the housing and receiving an alternating-current signal provided from an outside source; and
a vibration plate contacting at least the part of the upper surface of the yoke part and outputting vibration to outside according to vibration of the yoke part.

2. The vibration output device of claim 1, wherein the magnetic circuit vibrates according to a change in a magnetic field provided by the coil, and
wherein at least a part of the opened upper surface of the housing is curled, so that the elastic member is coupled with the housing.

3. The vibration output device of claim 1, wherein the elastic member includes an elastic body including a fixed part and a vibration part,
wherein the fixed part of the elastic body is coupled to the internal surface of the housing to be fixed, and the vibration part of the elastic body is in contact with at least the part of the upper surface of the yoke part, and
wherein the vibration part of the elastic body is positioned between the fixed part of the elastic body and the vibration plate.

4. The vibration output device of claim 1, wherein the elastic member further includes an elastic body suspension, and
wherein the elastic body suspension is arranged to contact at least a part of an upper surface of the elastic member and is formed in an opened annular shape with a center portion.

5. The vibration output device of claim 1, wherein the yoke part includes a yoke, and
wherein an upper surface of the yoke is molded in a form of a circular plate, and a lower surface of the yoke is molded in a form in which a cylinder is attached to a center portion of the circular plate.

6. The vibration output device of claim 5, wherein the yoke part further includes a yoke plate, and
wherein the yoke plate is positioned on the upper surface of the yoke to form at least one step on the upper surface of the yoke part.

7. The vibration output device of claim 1, wherein the yoke part is attached to at least a part of a lower surface of the elastic member.

8. The vibration output device of claim 1, wherein the magnetic circuit is attached to at least a part of a lower surface of the yoke part.

9. The vibration output device of claim 1, wherein the vibration plate is attached to at least the part of the upper surface of the yoke part.

10. The vibration output device of claim 1, wherein the vibration plate and the yoke part are coupled by a rivet.

11. The vibration output device of claim 1, wherein the magnetic circuit includes a magnet, a top plate, and a magnetic circuit guide, and
wherein the magnet, the top plate, and the yoke part are coupled by the magnetic circuit guide.

12. A vibration output speaker for outputting a sound by using vibration, the vibration output speaker comprising:
a vibration output unit;
a control unit controlling the vibration output unit and generating vibration;
wherein the vibration output unit generates vibration under control of the control unit, and
wherein the vibration output unit includes:
a magnetic circuit generating vibration;
a yoke part contacting an upper surface of the magnetic circuit;
an elastic member contacting at least a part of an upper surface of the yoke part and performing vibratory motion;
a housing having an opened upper surface, an opened lower surface and an internal space formed by close lateral surfaces;
a coil positioned inside the housing and receiving an alternating-current signal provided from an outside source; and
a vibration plate contacting at least the part of the upper surface of the yoke part and outputting vibration to outside according to vibration of the yoke part.
